(19) United States
(12) Patent Application Publication
(10) Pub. No.: US 2018/0276559 A1
(43) Pub. Date: Sep. 27, 2018

(54) DISPLAYING FEED CONTENT

(71) Applicant: salesforce.com, inc., San Francisco, CA (US)

(72) Inventors: Mrudula Kodali, San Francisco, CA (US); Sachin Desai, San Francisco, CA (US)

(21) Appl. No.: 15/466,625

(22) Filed: Mar. 22, 2017

(51) Int. Cl. G06N 99/00; G06F 17/30; H04L 29/08; H04L 12/58

(52) U.S. Cl. CPC G06N 99/005; H04L 51/32; H04L 67/306; G06F 17/30477

(57) ABSTRACT

Disclosed are examples of systems, apparatus, methods and computer program products for displaying feed content. Training content associated with a first user can be processed. Prospective content can be retrieved. A plurality of correspondence characteristics can be calculated. A subset of the prospective content can be identified. A feed comprising the subset of the prospective content can be displayed. It can be determined that the first user has interacted with the subset of the prospective content. At least one of the correspondence characteristics can be updated.

### COPYRIGHT NOTICE

A portion of the disclosure of this patent document contains material which is subject to copyright protection. The copyright owner has no objection to the facsimile reproduction by anyone of the patent document or the patent disclosure as it appears in the United States Patent and Trademark Office patent file or records but otherwise reserves all copyright rights whatsoever.

### TECHNICAL FIELD

This patent document generally relates to displaying feed content. More specifically, this patent document discloses techniques for displaying feed content of a feed of a social networking system.

### BACKGROUND

“Cloud computing” services provide shared resources, applications, and information to computers and other devices upon request. In cloud computing environments, services can be provided by one or more servers accessible over the Internet rather than installing software locally on in-house computer systems. Users can interact with cloud computing services to undertake a wide range of tasks including tasks relating to social networking systems.

### BRIEF DESCRIPTION OF THE DRAWINGS

The included drawings are for illustrative purposes and serve only to provide examples of possible structures and operations for the disclosed inventive systems, apparatus, methods and computer program products. These drawings in no way limit any changes in form and detail that may be made by one skilled in the art without departing from the spirit and scope of the disclosed implementations.

FIG. 1 shows a flowchart of an example of a method 100 for displaying feed content, in accordance with some implementations.

FIG. 2 shows an example of a social networking post as displayed on a computing device, in accordance with some implementations.

FIG. 3A shows example of a table containing exemplary weights applicable in a predictive algorithm, in accordance with some implementations.

FIG. 3B shows another example of a table containing exemplary weights applicable in a predictive algorithm, in accordance with some implementations.

FIG. 4A shows an example of a presentation of a social networking feed as displayed on a computing device, in accordance with some implementations.

FIG. 4B shows another example of a table containing exemplary weights applicable in a predictive algorithm, in accordance with some implementations.

FIG. 5A shows a block diagram of an example of an environment 10 in which an on-demand database service can be used in accordance with some implementations.

FIG. 5B shows a block diagram of an example of some implementations of elements of FIG. 5A and various possible interconnections between these elements.

FIG. 6A shows a system diagram of an example of architectural components of an on-demand database service environment 900, in accordance with some implementations.

FIG. 6B shows a system diagram further illustrating an example of architectural components of an on-demand database service environment, in accordance with some implementations.

### DETAILED DESCRIPTION

Examples of systems, apparatus, methods and computer program products according to the disclosed implementations are described in this section. These examples are being provided solely to add context and aid in the understanding of the disclosed implementations. It will thus be apparent to one skilled in the art that implementations may be practiced without some or all of these specific details. In other instances, certain operations have not been described in detail to avoid unnecessarily obscuring implementations. Other applications are possible, such that the following examples should not be taken as definitive or limiting either in scope or setting.

In the following detailed description, references are made to the accompanying drawings, which form a part of the description and in which are shown, by way of illustration, specific implementations. Although these implementations are described in sufficient detail to enable one skilled in the art to practice the disclosed implementations, it is understood that these examples are not limiting, such that other implementations may be used and changes may be made without departing from their spirit and scope. For example, the operations of methods shown and described herein are not necessarily performed in the order indicated. It should also be understood that the methods may include more or fewer operations than are indicated. In some implementations, operations described herein as separate operations may be combined. Conversely, what may be described herein as a single operation may be implemented in multiple operations.

Some implementations of the disclosed systems, apparatus, methods and computer program products are configured for displaying feed content, which generally refers to any type of content that can be included in a feed, such as a feed of a social networking system, as discussed further below.

Existing enterprise social networking systems do not present users with feeds that are automatically curated based on users' past interactions with content. As such, users of conventional enterprise social networking systems may miss important content. By way of example, Tim is a branch manager at the Scrooge Organization, a large multinational charity organization with a number of branch offices. Tim's branch provides microloans in developing countries. Belle works at a different branch of the Scrooge Organization on a different continent. She heads up Scrooge's efforts to provide preventative medical care to disenfranchised groups. Tim is in the process of surveying health economics literature in his effort to provide microloans to build hospitals. He posts a series of articles relating to quality of and access to medical care. The articles posted by Tim have the potential to revolutionize Belle's work, which could increase efficiency and help provide tens of thousands of people with access to better medical care. Unfortunately, Belle and Tim are unfamiliar with each other's work since they live on different continents. Therefore, Belle has no way of receiving feed content that is authored and/or posted by Tim.

By contrast, the disclosed techniques may be implemented to use a user's past behavior as training data to estimate whether content will be important or interesting to her. A subset of content available to the user's organization can be automatically selected using algorithms trained with the training data. A curated feed containing this subset of content can then be displayed on the user's device. As discussed below, unlike conventional social networking systems, the algorithms can then be retrained based on how the user interacts with her curated feed. Accordingly, returning to the example discussed in the preceding paragraph, Belle can be presented with relevant articles posted by Tim that are identified using the above-described algorithms.

In some implementations, content can be included in a curated feed based on whether the content is “trending.” By way of example, a post has been actively and repeatedly interacted with by a large number of users affiliated with Scrooge Organization. As such, the post can be defined as trending, such that it is assigned greater weight in the algorithms described in the preceding paragraph. Therefore, a user can be presented with relevant content that is also actively interacted with by users affiliated with her organization.

Some but not all of the techniques described or referenced herein are implemented using a social networking system. Social networking systems have become a popular way to facilitate communication among people, any of whom can be recognized as users of a social networking system. One example of a social networking system is Chatter®, provided by salesforce.com, inc. of San Francisco, Calif. salesforce.com, inc. is a provider of social networking services, customer relationship management (CRM) services and other database management services, any of which can be accessed and used in conjunction with the techniques disclosed herein in some implementations. These various services can be provided in a cloud computing environment, for example, in the context of a multi-tenant database system. Thus, the disclosed techniques can be implemented without having to install software locally, that is, on computing devices of users interacting with services available through the cloud. While the disclosed implementations are often described with reference to Chatter®, those skilled in the art should understand that the disclosed techniques are neither limited to Chatter® nor to any other services and systems provided by salesforce.com, inc. and can be implemented in the context of various other database systems and/or social networking systems such as Facebook®, LinkedIn®, Twitter®, Google+®, Yammer® and Jive® by way of example only.

Some social networking systems can be implemented in various settings, including organizations. For instance, a social networking system can be implemented to connect users within an enterprise such as a company or business partnership, or a group of users within such an organization. For instance, Chatter® can be used by employee users in a division of a business organization to share data, communicate, and collaborate with each other for various social purposes often involving the business of the organization. In the example of a multi-tenant database system, each organization or group within the organization can be a respective tenant of the system, as described in greater detail below.

In some social networking systems, users can access one or more social network feeds, which include updates presented as items or entries in the feed. Such a feed item can include a single update or a collection of individual updates. A feed item can include various types of data including character-based data, audio data, image data and/or video data. A social network feed can be displayed in a GUI on a display device such as the display of a computing device as described below. The updates can include various social network data from various sources and can be stored in an on-demand database service environment. In some implementations, the disclosed methods, apparatus, systems, and computer program products may be configured or designed for use in a multi-tenant database environment.

In some implementations, a social networking system may allow a user to follow data objects in the form of CRM records such as cases, accounts, or opportunities, in addition to following individual users and groups of users. The “following” of a record stored in a database, as described in greater detail below, allows a user to track the progress of that record when the user is subscribed to the record. Updates to the record, also referred to herein as changes to the record, are one type of update that can occur and be noted on a social network feed such as a record feed or a news feed of a user subscribed to the record. Examples of record updates include field changes in the record, updates to the status of a record, as well as the creation of the record itself. Some records are publicly accessible, such that any user can follow the record, while other records are private, for which appropriate security clearance/permissions are a prerequisite to a user following the record.

Updates can include various types of updates, which may or may not be linked with a particular record. For example, updates can be social media messages submitted by a user or can otherwise be generated in response to user actions or in response to events. Examples of social media messages include: posts, comments, indications of a user's personal preferences such as “likes” and “dislikes”, updates to a user's status, uploaded files, and user-submitted hyperlinks to social network data or other network data such as various documents and/or web pages on the Internet. Posts can include alpha-numeric or other character-based user inputs such as words, phrases, statements, questions, emotional expressions, and/or symbols. Comments generally refer to responses to posts or to other updates, such as words, phrases, statements, answers, questions, and reactionary emotional expressions and/or symbols. Multimedia data can be included in, linked with, or attached to a post or comment. For example, a post can include textual statements in combination with a JPEG image or animated image. A like or dislike can be submitted in response to a particular post or comment. Examples of uploaded files include presentations, documents, multimedia files, and the like.

Users can follow a record by subscribing to the record, as mentioned above. Users can also follow other entities such as other types of data objects, other users, and groups of users. Feed tracked updates regarding such entities are one type of update that can be received and included in the user's news feed. Any number of users can follow a particular entity and thus view updates pertaining to that entity on the users' respective news feeds. In some social networks, users may follow each other by establishing connections with each other, sometimes referred to as “friending” one another. By establishing such a connection, one user may be able to see information generated by, generated about, or otherwise associated with another user. For instance, a first user may be able to see information posted by a second user to the second user's personal social network page. One implementation of such a personal social network page is a user's profile page, for example, in the form of a web page representing the user's profile. In one example, when the first user is following the second user, the first user's news feed can receive a post from the second user submitted to the second user's profile feed. A user's profile feed is also referred to herein as the user's “wall,” which is one example of a social network feed displayed on the user's profile page.

In some implementations, a social network feed may be specific to a group of users of a social networking system. For instance, a group of users may publish a news feed. Members of the group may view and post to this group feed in accordance with a permissions configuration for the feed and the group. Updates in a group context can also include changes to group status information.

In some implementations, when data such as posts or comments input from one or more users are submitted to a social network feed for a particular user, group, object, or other construct within a social networking system, an email notification or other type of network communication may be transmitted to all users following the user, group, or object in addition to the inclusion of the data as a feed item in one or more feeds, such as a user's profile feed, a news feed, or a record feed. In some social networking systems, the occurrence of such a notification is limited to the first instance of a published input, which may form part of a larger conversation. For instance, a notification may be transmitted for an initial post, but not for comments on the post. In some other implementations, a separate notification is transmitted for each such update.

The term “multi-tenant database system” generally refers to those systems in which various elements of hardware and/or software of a database system may be shared by one or more customers. For example, a given application server may simultaneously process requests for a great number of customers, and a given database table may store rows of data such as feed items for a potentially much greater number of customers.

An example of a “user profile” or “user's profile” is a database object or set of objects configured to store and maintain data about a given user of a social networking system and/or database system. The data can include general information, such as name, title, phone number, a photo, a biographical summary, and a status, e.g., text describing what the user is currently doing. As mentioned below, the data can include social media messages created by other users. Where there are multiple tenants, a user is typically associated with a particular tenant. For example, a user could be a salesperson of a company, which is a tenant of the database system that provides a database service.

The term “record” generally refers to a data entity having fields with values and stored in database system. An example of a record is an instance of a data object created by a user of the database service, for example, in the form of a CRM record about a particular (actual or potential) business relationship or project. The record can have a data structure defined by the database service (a standard object) or defined by a user (custom object). For example, a record can be for a business partner or potential business partner (e.g., a client, vendor, distributor, etc.) of the user, and can include information describing an entire company, subsidiaries, or contacts at the company. As another example, a record can be a project that the user is working on, such as an opportunity (e.g., a possible sale) with an existing partner, or a project that the user is trying to get. In one implementation of a multi-tenant database system, each record for the tenants has a unique identifier stored in a common table. A record has data fields that are defined by the structure of the object (e.g., fields of certain data types and purposes). A record can also have custom fields defined by a user. A field can be another record or include links thereto, thereby providing a parent-child relationship between the records.

The terms “social network feed” and “feed” are used interchangeably herein and generally refer to a combination (e.g., a list) of feed items or entries with various types of information and data. Such feed items can be stored and maintained in one or more database tables, e.g., as rows in the table(s), that can be accessed to retrieve relevant information to be presented as part of a displayed feed. The term “feed item” (or feed element) generally refers to an item of information, which can be presented in the feed such as a post submitted by a user. Feed items of information about a user can be presented in a user's profile feed of the database, while feed items of information about a record can be presented in a record feed in the database, by way of example. A profile feed and a record feed are examples of different types of social network feeds. A second user following a first user and a record can receive the feed items associated with the first user and the record for display in the second user's news feed, which is another type of social network feed. In some implementations, the feed items from any number of followed users and records can be combined into a single social network feed of a particular user.

As examples, a feed item can be a social media message, such as a user-generated post of text data, and a feed tracked update to a record or profile, such as a change to a field of the record. Feed tracked updates are described in greater detail below. A feed can be a combination of social media messages and feed tracked updates. Social media messages include text created by a user, and may include other data as well. Examples of social media messages include posts, user status updates, and comments. Social media messages can be created for a user's profile or for a record. Posts can be created by various users, potentially any user, although some restrictions can be applied. As an example, posts can be made to a wall section of a user's profile page (which can include a number of recent posts) or a section of a record that includes multiple posts. The posts can be organized in chronological order when displayed in a GUI, for instance, on the user's profile page, as part of the user's profile feed. In contrast to a post, a user status update changes a status of a user and can be made by that user or an administrator. A record can also have a status, the update of which can be provided by an owner of the record or other users having suitable write access permissions to the record. The owner can be a single user, multiple users, or a group.

In some implementations, a comment can be made on any feed item. In some implementations, comments are organized as a list explicitly tied to a particular feed tracked update, post, or status update. In some implementations, comments may not be listed in the first layer (in a hierarchal sense) of feed items, but listed as a second layer branching from a particular first layer feed item.

A “feed tracked update,” also referred to herein as a “feed update,” is one type of update and generally refers to data representing an event. A feed tracked update can include text generated by the database system in response to the event, to be provided as one or more feed items for possible inclusion in one or more feeds. In one implementation, the data can initially be stored, and then the database system can later use the data to create text for describing the event. Both the data and/or the text can be a feed tracked update, as used herein. In various implementations, an event can be an update of a record and/or can be triggered by a specific action by a user. Which actions trigger an event can be configurable. Which events have feed tracked updates created and which feed updates are sent to which users can also be configurable. Social media messages and other types of feed updates can be stored as a field or child object of the record. For example, the feed can be stored as a child object of the record.

A “group” is generally a collection of users. In some implementations, the group may be defined as users with a same or similar attribute, or by membership. In some implementations, a “group feed”, also referred to herein as a “group news feed”, includes one or more feed items about any user in the group. In some implementations, the group feed also includes updates and other feed items that are about the group as a whole, the group's purpose, the group's description, and group records and other objects stored in association with the group. Threads of updates including group record updates and social media messages, such as posts, comments, likes, etc., can define group conversations and change over time.

An “entity feed” or “record feed” generally refers to a feed of feed items about a particular record in the database. Such feed items can include feed tracked updates about changes to the record and posts made by users about the record. An entity feed can be composed of any type of feed item. Such a feed can be displayed on a page such as a web page associated with the record, e.g., a home page of the record. As used herein, a “profile feed” or “user's profile feed” generally refers to a feed of feed items about a particular user. In one example, the feed items for a profile feed include posts and comments that other users make about or send to the particular user, and status updates made by the particular user. Such a profile feed can be displayed on a page associated with the particular user. In another example, feed items in a profile feed could include posts made by the particular user and feed tracked updates initiated based on actions of the particular user.

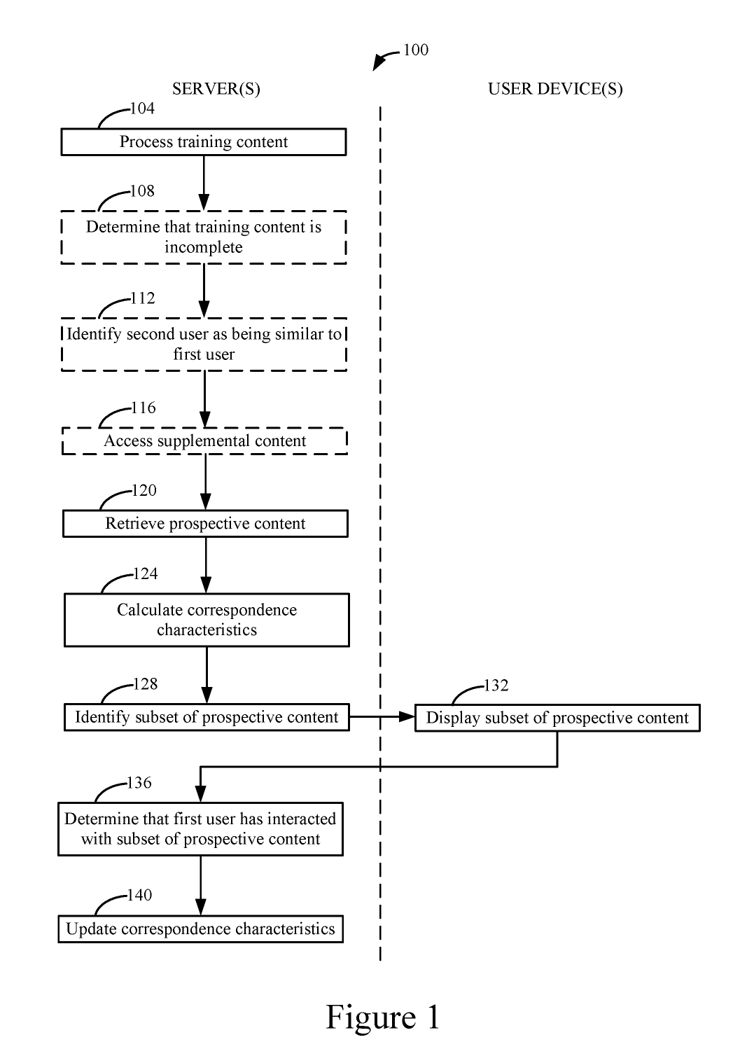

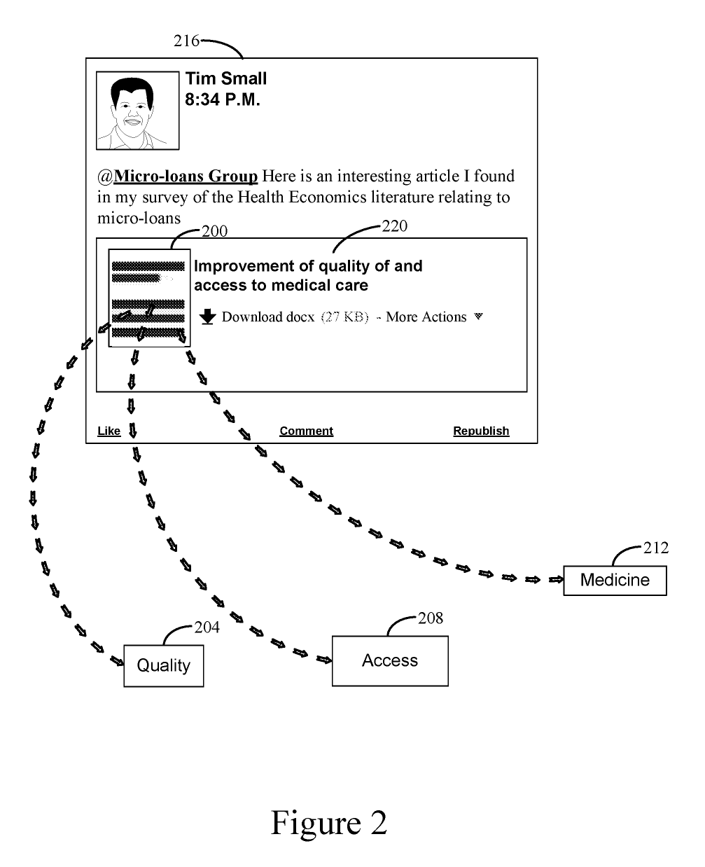

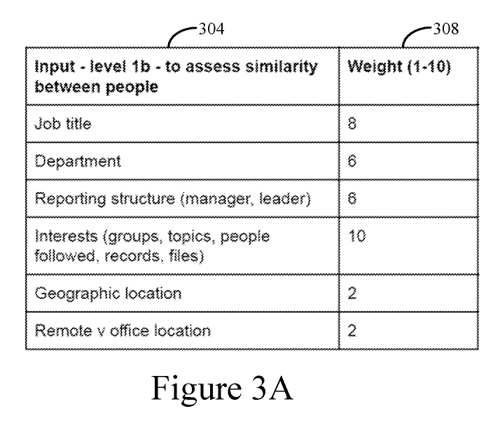

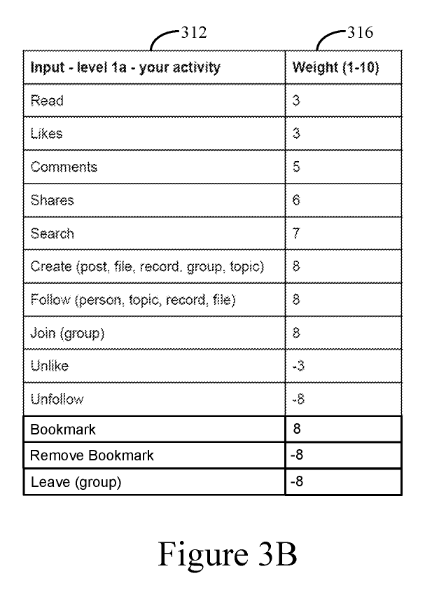

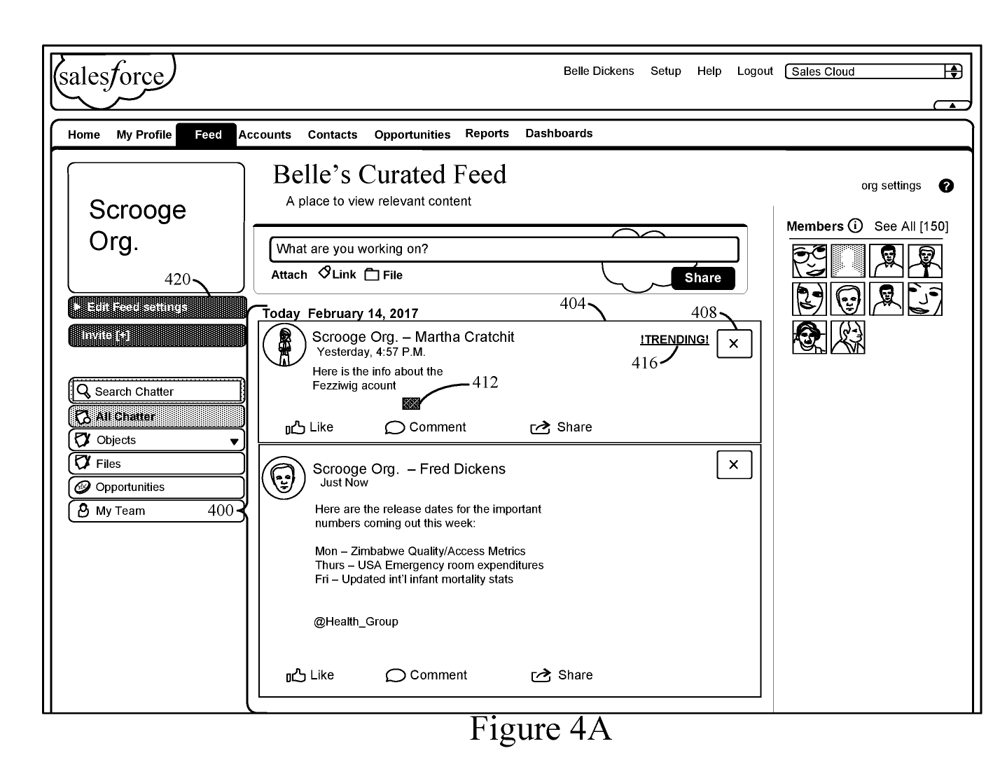

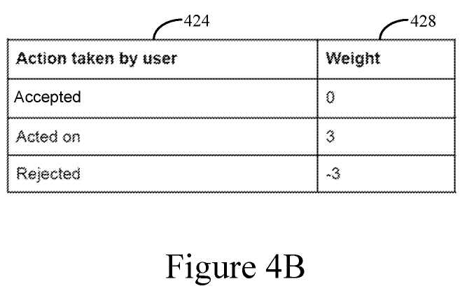

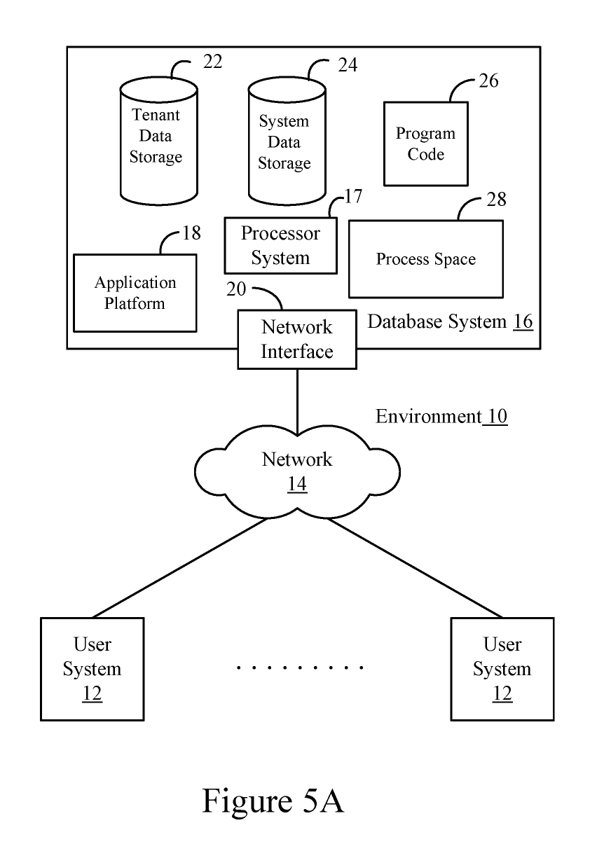

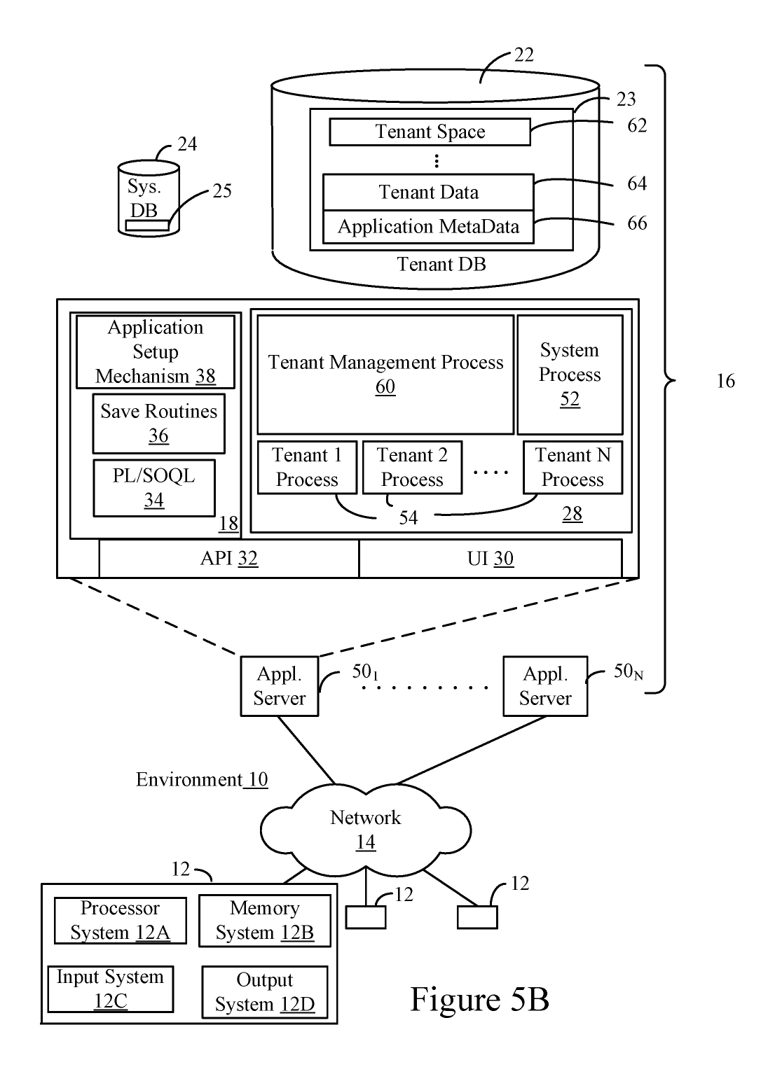

FIG. 1 shows a flowchart of an example of a method 100 for displaying feed content, in accordance with some implementations. Method 100 may be performed using a server system and database system such as database system 16 of FIGS. 5A and 5B, described further below. However, implementations of method 100 are not limited to database system 16. FIG. 1 is described with reference to FIGS. 2-4B. FIG. 2 shows an example of a social networking post as displayed on a computing device, in accordance with some implementations. FIG. 3A shows example of a table containing exemplary weights applicable in a predictive algorithm, in accordance with some implementations. FIG. 3B shows another example of a table containing exemplary weights applicable in a predictive algorithm, in accordance with some implementations. FIG. 4A shows an example of a presentation of a social networking feed as displayed on a computing device, in accordance with some implementations. FIG. 4B shows another example of a table containing exemplary weights applicable in a predictive algorithm, in accordance with some implementations.

In some implementations, the social networking systems described herein may be implemented in an environment with a number of different member organizations. Data of each member organization may be separated such that users affiliated with a particular member organization only have access to the particular member organization's data. For example, such an environment may be implemented using a multi-tenant system, as discussed in further detail below. By way of illustration, since Belle is affiliated with Scrooge Organization, she can access content available to members affiliated with Scrooge Organization. On the other hand, since Belle is not affiliated with any Twist Corporation, she cannot access content available only to users affiliated with Twist Corporation.

At 104 of FIG. 1, training content is processed. Such training content can include any content with which a user of a social networking system, such as Belle, has interacted. By way of example, such content can include, but is not limited to, posts, comments, files, topics, profiles of other users of the social networking system, a group of users of the social networking system, database records such as Customer Relationship Management (CRM) records, searches, links, and/or bookmarks.

By way of illustration, the training content processed at 104 of FIG. 1 may include file 200 of FIG. 2 in social networking post 216. File 200 is an article surrounding the improvement of quality of and access to medical care in the form of a .docx Microsoft Word® having filename 220 of “Improvement of quality of and access to medical care.” File 200 may be included in the training content for Belle because Belle downloaded file 200.

Although file 200 of FIG. 2 takes the form of a file attached to social networking post 216, training content may include a range of material, as described above. Additionally, while file 200 is an article in the form of a .docx file, a variety of other files such as, a PowerPoint® (.ppt) file, a Portable Document Format (.pdf) file, a Joint Photographic Experts Group (.jpeg) file, a Waveform Audio (.wav) file, a Moving Pictures Experts Group (.mpeg) file, etc., may be received and processed using some of the disclosed techniques, as described below.

In some implementations, processing training content may include extraction of keywords from the training content. Returning to the above-described example, processing of file 200 may include the extraction of keywords such as quality 204, access 208, and medicine 212. Processing file 200 to extract keywords quality 204, access 208, and medicine 212 can be accomplished in a variety of manners. For example, the contents of file 200 can be parsed using standard parsing techniques. Each parsed word can be indexed and stored as a keyword for file 200 in a database. Similarly, filename 220 of “Improvement of quality of and access to medical care” can be parsed and each parsed word can be stored in the database. Also or alternatively, only a subset of the content of file 200 may be extracted. For instance, since titles or headings may indicate the most important subject matter contained in file 200, only titles or headings can be extracted from file 200 as keywords. Also or alternatively, if training content takes a form other than a file, such as a post or comment, textual content of the training content can be parsed and keywords extracted using the techniques described above.

In some implementations, common words such as “is”, “and”, “of”, “the”, etc. may be ignored and not extracted from training content as keywords. By way of illustration, a numerical statistic such as Term Frequency-Inverse Document Frequency (TF-IDF) can be determined for words contained in file 200. A TF-IDF threshold can be chosen such that any words having a TF-IDF lower than the threshold can be ignored and any words having TF-IDF higher than the threshold can be extracted from file 200 as keywords.

The manner in which extraction of keywords is performed may vary depending on the type of training content being processed. For instance, text may be extracted from a social networking post or a file such as post 216 or file 200. The extracted text from post 216 or file 200 may be parsed and keywords may be extracted, as described above. Alternatively, an image file, such as a .jpeg file, might contain embedded metadata, such as Extensible Metadata Platform (XMP) metadata, that can be parsed and extracted as keywords. Also or alternatively, standard image recognition techniques may be applied to an image and/or video file to determine textual representations of content of the image or video file. Such textual representations may be used as keywords. Keywords might also be extracted from an audio or video post by converting the audio or video contents of the post to text using standard automated speech recognition (ASR) techniques. Such text can be parsed and keywords can be extracted, as described above.

In some, but not all, implementations, at 108 of FIG. 1, it is determined that the training content is incomplete. By way of example, Marley is a new employee of Scrooge Organization. He has only interacted with one hundred content items in his short time at Scrooge Organization. As such, using Marley's past interactions with content items alone as training data may not allow for a robust predictive analytic model to identify prospective content for presentation to Marley in a curated feed, as discussed further below.

In some implementations, a particular minimum amount of training content may be desirable in order for a predictive model to be run using the training content. By way of example, if a user has interacted with a certain threshold number of content items, e.g., 1,200 content items, there may be sufficient training data for a robust model. On the other hand, if the user has interacted with less than the threshold number of content items, e.g., 100 content items, supplemental content may serve as proxy for the missing 1,100 data points, as described below in the context of 116 of FIG. 1.

In some, but not all, implementations, at 112 of FIG. 1, a further user is identified as being similar to a user with incomplete training content. By way of example, a machine learning algorithm such as an affinity algorithm, e.g., the Facebook® EdgeRank algorithm, may calculate scores based on observable factors that may predict similarity between users, e.g., factors 304 depicted in FIG. 3A. Each factor 304 may have a default weight in the affinity algorithm e.g., weights 308 of FIG. 3A. The affinity algorithm may calculate Ebenezer as having the highest affinity score for Marley. As such, Ebenezer may be identified at 112 of FIG. 1 as a user who is similar to Marley.

One having skill in the art can appreciate that while several exemplary weights 308 and factors 304 are depicted in FIG. 3A, a variety of different weights and/or factors may be used with a range of different algorithms to identify similar users of a social networking system without departing from the spirit and scope of this disclosure. By way of example, geographic location, which is a factor 304, may be used to assess similarity between users affiliated with an organization that has offices in several locations using an affinity algorithm, as described above. On the other hand, if an organization has a single office in a single city, geographic location would have little to no predictive value in assessing similarity between users of the organization.

In some, but not all, implementations, at 116 of FIG. 1, supplemental content is accessed. The supplemental content may be accessed in response to determining that the training content is incomplete at 112 of FIG. 1.

For example, in some implementations, the supplemental content may include historical activity data of a further user that has been identified as being similar to a user with incomplete training content. By way of example, since Ebenezer was identified as similar to Marley at 112 of FIG. 1, Ebenezer's historical activity data, e.g. content with which he has previously interacted, may serve as supplemental content that can be combined with Marley's training content to calculate correspondence characteristics for Marley, as discussed in further detail below.

Also or alternatively, supplemental content may include a user's data from an external system. By way of illustration, Marley may give his Linkedin® login credentials to an administrator at Scrooge Organization. The administrator may then mine Linkedin® for Marley's, profile information, past interactions with content in the Linkedin® system, etc. The data mined from Linkedin® can then serve as supplemental content that can be combined with Marley's training content to calculate correspondence characteristics for Marley, as discussed in further detail below.

At 120 of FIG. 1 prospective content is retrieved. Prospective content generally refers to any content that is available to users affiliated with a particular member organization. Prospective content is a pool of content from which a curated feed may be generated.

At 124 of FIG. 1, correspondence characteristics for prospective content are calculated based on actions taken by a user with respect to the training content. Such correspondence characteristics generally refer to quantitative or qualitative measures that can be used by a predictive analytic algorithm to predict whether prospective content would be of interest to a particular user. For instance, a correspondence characteristic may be a sum of numerical values generated by predictive analyses of the training content, as described further below in the context of 128 of FIG. 1. By way of example, a correspondence characteristic for a particular keyword for Belle may be a numerical score generated by machine learning algorithms and/or other predictive analytics that may have predictive value in determining whether content containing the particular keyword would be of interest to Belle.

A variety of actions taken by a user with respect to the training content can be used in calculating correspondence characteristics. By way of example, such actions may include subscribing to a topic, following a user, searching for a term, becoming a member of the group of users of the social networking system, generating or modifying a database record such as CRM record, viewing a file, uploading a file, commenting on a file, liking a file, sharing a file, modifying a file, authoring a post, commenting on a post, liking a post, sharing a post, and/or bookmarking an object.

By way of example, correspondence characteristics for Belle may be calculated by applying a machine learning algorithm to Belle's training content using past interactions 312 of FIG. 3B and corresponding weights 316. Weights 316 for the past interactions 312 of reading content, liking content, commenting on content, sharing content, searching, creating content, following a person topic record or file, bookmarking a post or an object, and joining a group have positive values; therefore, any instance of these actions by a user on content containing particular keywords may cause his or her correspondence characteristics for the particular keywords to be increased accordingly. On the other hand weights 316 for the past interactions 312 of unliking, removing a bookmark, leaving a group, and unfollowing have negative values; therefore, any instance of these actions by a user on content containing particular keywords may cause his or her correspondence characteristics for the particular keywords to be decreased accordingly.

Weights 316 of FIG. 3B provide one example of default weights that may be used when implementing the disclosed techniques. One having skill in the art can appreciate that the numerical values of such weights may be arbitrary and can be varied without departing from the scope of this disclosure. Also or alternatively, weights for a particular user may be automatically modified as a machine learning algorithm is trained using the user's training content and/or her interactions with her curated feed, as discussed below.

In some implementations, correspondence characteristics may be calculated based on indications of sentiment in content authored by a user. By way of example, a standard sentiment algorithm can be applied to keywords extracted from training content authored by a user, e.g., her posts, comments, search terms, and/or topics mentioned or followed. For examples and descriptions of several sentiment algorithms that may be used, please refer to the paper “Sentiment analysis algorithms and applications: A survey.” by Walaa Medhat, Ahmed Hassan, and Hoda Korashy published in Ain Shams Engineering Journal 5.4 (2014): 1093-1113, the entirety of which is incorporated herein by reference for all purposes.

Also or alternatively, correspondence characteristics may include scores calculated using affinity algorithms, such as the Facebook® EdgeRank algorithm, as discussed above. By way of example, the network of people who a user follows as well as her group membership may demonstrate her affinity. Moreover, she may be interested in content that is interesting to users with whom she has a high affinity.

In some implementations, correspondence characteristics may include an aggregate sum of numerical values calculated using the algorithms trained using training content as described above. By way of example, a correspondence characteristic for an item of prospective content may include a weighted or unweighted sum of a keyword score based on past activity of a user, a sentiment score based on a user's authored content, and/or an affinity score described above.

In some implementations, correspondence characteristics may be calculated based on the supplemental content accessed at 116 of FIG. 1. By way of illustration, as described above, if the training content is determined to be incomplete at 108, the supplemental content may be used in calculation of correspondence characteristics. For example, when the algorithms described above are being applied to calculate correspondence characteristics for Marley, the algorithms may use both Marley's past interactions with training content and data mined from his linked-in profile and/or training content of Ebenezer who has been identified as being similar to Marley as training data.

At 128 of FIG. 1, a subset of the prospective content is identified for presentation to a user. For example, the algorithms described above may be applied to prospective content to identify a subset of the prospective content, which has a sufficiently high score for a particular user. As discussed above, such algorithms may be applied using the correspondence characteristics calculated at 124 of FIG. 1. As discussed below, this subset of the prospective content may be presented to the particular user in a curated feed. By way of illustration, feed item 404 of FIG. 4A may be included in the prospective content for Belle because feed item 404 is available to users affiliated with the Scrooge Organization. Feed item 404 of FIG. 4A may be selected for presentation to Belle based on the correspondence characteristics calculated at 124 of FIG. 1 because the aggregate sum of the keyword score of feed item 404 based on Belle's past activity, the sentiment score of feed item 404 based on Belle's authored content, and/or the affinity score of feed item 404 is sufficiently high. In some implementations, a user's curated feed may have a particular number of the highest ranked items for the user from the prospective content, e.g., the 100 items with the highest correspondence characteristics for the user. Alternatively, a user's curated feed may contain any prospective content that has a correspondence characteristic for the user higher than a certain threshold value.

As discussed above, trending content can be more heavily weighted such that a user is presented with not only relevant content, but also content that is actively interacted with across her organization. For example, identification of the subset of the prospective content for presentation in a curated feed can be based on an overall level of activity associated with the prospective content. By way of example, feed item 404 of FIG. 4A may be placed at the top of curated feed 400 because feed item 404 is trending. In some implementations, a feed item of a curated feed may include a visual indication that the feed item is trending. By way of example, feed item 404 includes indicator 416, which indicates that feed item 404 is trending in the Scrooge Organization.

At 132 of FIG. 1, the subset of the prospective content is displayed on a device of a user. By way of example, curated feed 400 of FIG. 4A, which includes the subset of the prospective content identified at 128 of FIG. 1, may be displayed on Belle's computing device. Curated feed 400 may be displayed in response to the subset of the prospective content having been identified for presentation to Belle at 128.

At 136 of FIG. 1, it is determined that a user has interacted with the subset of the prospective content. By way of example, Belle may click or tap “reject button” 408 of FIG. 4A if she is not interested in the content of feed item 404 or file 412, which is attached to feed item 404. A server system can receive data indicating that Belle has clicked reject button 408. The server system can then process the data, extracting keywords from the contents of feed item 404 and file 412 using the techniques described above in the context of 104 of FIG. 1.

Alternatively, Belle may download file 412 of FIG. 4A or reply to feed item 404 if she is interested in the content of feed item 404 or file 412. A server system can receive data indicating that downloaded file 412 or replied to feed item 404. The server system can then process the data, extracting keywords from the contents of feed item 404 and file 412 using the techniques described above in the context of 104 of FIG. 1.

At 140 of FIG. 1, the correspondence characteristics are updated based on an attribute of the interaction of a user with the subset of the prospective content. By way of example, a variety of types of interactions by Belle with the content displayed in curated feed 400 of FIG. 4 may correspond to particular weights that may be applied to improve the algorithms described above. For instance, in one example, each of the actions 424 of FIG. 4B may correspond to weights 428. By way of illustration, if it is determined at 136 of FIG. 1 that Belle has clicked or tapped reject button 408 of FIG. 4A, the action 424 of rejecting a feed item is associated with a weight 428 of negative 3. As such, her rejection of feed item 404 may cause correspondence characteristics of any keywords contained in feed item 404 and file 412 to be decreased accordingly. Similarly, if Belle does not interact with feed item 404 at all, the action 424 of accepting content corresponds to the weight of 0. Therefore, in this scenario, Belle's correspondence characteristics will remain unchanged. On the other hand, if it is determined at 136 of FIG. 1 that Belle has replied to and/or shared feed item 404 or downloaded file 412 of FIG. 4A, the action 424 of FIG. 4B of acting on a feed item is associated with a weight 428 of positive 3. As such, her acting on feed item 404 may cause correspondence characteristics of any keywords contained in feed item 404 and file 412 to be increased accordingly. Such updating of correspondence characteristics may help further train the algorithms described above to promote better tailored content. As such, curated feed 400 can be updated in real time or near real time such that Belle is presented with recent and relevant information whenever she views curated feed 400.

Weights 428 of FIG. 4B provide one example of default weights that may be used when implementing the disclosed techniques. One having skill in the art can appreciate that the numerical values of such weights may be arbitrary and can be varied without departing from the scope of this disclosure. Also or alternatively, weights for a particular user may be automatically modified as a machine learning algorithm is trained using the user's training content and/or her interactions with her curated feed, as discussed below.

Also or alternatively, the algorithms described above may be trained based on an aggregate number of interactions with content of curated feeds by a variety of users. For example, Belle may repeatedly view feed item 404 of FIG. 4A because she finds the content of feed item 404 so engaging or valuable. Also or alternatively, multiple users may have been recommended the feed item 404, which also leads to a high view count. As such, the algorithms described above may be trained to apply an even higher value to feed item 404 and propagate feed item 404 even further within the user network of the Scrooge Organization.

In some implementations, a user may change her curated feed settings manually. By way of example, Belle may click or tap “edit feed settings button” 420. She may then be presented with a screen that allows her to manually change the settings for her curated feed. For instance, she may wish to not see trending content, she may wish to manually add or remove topics in which she is interested, she may wish to limit the number of feed items in her curated feed, etc.

In some implementations, a variety of predictive analytic models may be used in lieu of the algorithms described above. By way of example, a plethora of machine learning models, e.g. a classification model such as random forest or random tree model, may be used. Also or alternatively, standard Frequentist or Bayesian statistical inference can be applied as a substitute for such machine learning models.

Systems, apparatus, and methods are described below for implementing database systems and enterprise level social and business information networking systems in conjunction with the disclosed techniques. Such implementations can provide more efficient use of a database system. For instance, a user of a database system may not easily know when important information in the database has changed, e.g., about a project or client. Such implementations can provide feed tracked updates about such changes and other events, thereby keeping users informed.

By way of example, a user can update a record in the form of a CRM object, e.g., an opportunity such as a possible sale of 1000 computers. Once the record update has been made, a feed tracked update about the record update can then automatically be provided, e.g., in a feed, to anyone subscribing to the opportunity or to the user. Thus, the user does not need to contact a manager regarding the change in the opportunity, since the feed tracked update about the update is sent via a feed to the manager's feed page or other page.

FIG. 5A shows a block diagram of an example of an environment 10 in which an on-demand database service exists and can be used in accordance with some implementations. Environment 10 may include user systems 12, network 14, database system 16, processor system 17, application platform 18, network interface 20, tenant data storage 22, system data storage 24, program code 26, and process space 28. In other implementations, environment 10 may not have all of these components and/or may have other components instead of, or in addition to, those listed above.

A user system 12 may be implemented as any computing device(s) or other data processing apparatus such as a machine or system used by a user to access a database system 16. For example, any of user systems 12 can be a handheld and/or portable computing device such as a mobile phone, a smartphone, a laptop computer, or a tablet. Other examples of a user system include computing devices such as a work station and/or a network of computing devices. As illustrated in FIG. 5A (and in more detail in FIG. 5B) user systems 12 might interact via a network 14 with an on-demand database service, which is implemented in the example of FIG. 5A as database system 16.

An on-demand database service, implemented using system 16 by way of example, is a service that is made available to users who do not need to necessarily be concerned with building and/or maintaining the database system. Instead, the database system may be available for their use when the users need the database system, i.e., on the demand of the users. Some on-demand database services may store information from one or more tenants into tables of a common database image to form a multi-tenant database system (MTS). A database image may include one or more database objects. A relational database management system (RDBMS) or the equivalent may execute storage and retrieval of information against the database object(s). Application platform 18 may be a framework that allows the applications of system 16 to run, such as the hardware and/or software, e.g., the operating system. In some implementations, application platform 18 enables creation, managing and executing one or more applications developed by the provider of the on-demand database service, users accessing the on-demand database service via user systems 12, or third party application developers accessing the on-demand database service via user systems 12.

The users of user systems 12 may differ in their respective capacities, and the capacity of a particular user system 12 might be entirely determined by permissions (permission levels) for the current user. For example, when a salesperson is using a particular user system 12 to interact with system 16, the user system has the capacities allotted to that salesperson. However, while an administrator is using that user system to interact with system 16, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level, also called authorization.

Network 14 is any network or combination of networks of devices that communicate with one another. For example, network 14 can be any one or any combination of a LAN (local area network), WAN (wide area network), telephone network, wireless network, point-to-point network, star network, token ring network, hub network, or other appropriate configuration. Network 14 can include a TCP/IP (Transfer Control Protocol and Internet Protocol) network, such as the global internetwork of networks often referred to as the Internet. The Internet will be used in many of the examples herein. However, it should be understood that the networks that the present implementations might use are not so limited.

User systems 12 might communicate with system 16 using TCP/IP and, at a higher network level, use other common Internet protocols to communicate, such as HTTP, FTP, AFS, WAP, etc. In an example where HTTP is used, user system 12 might include an HTTP client commonly referred to as a “browser” for sending and receiving HTTP signals to and from an HTTP server at system 16. Such an HTTP server might be implemented as the sole network interface 20 between system 16 and network 14, but other techniques might be used as well or instead. In some implementations, the network interface 20 between system 16 and network 14 includes load sharing functionality, such as round-robin HTTP request distributors to balance loads and distribute incoming HTTP requests evenly over a plurality of servers. At least for users accessing system 16, each of the plurality of servers has access to the MTS' data; however, other alternative configurations may be used instead.

In one implementation, system 16, shown in FIG. 5A, implements a web browser-based CRM system. For example, in one implementation, system 16 includes application servers configured to implement and execute CRM software applications as well as provide related data, code, forms, web pages and other information to and from user systems 12 and to store to, and retrieve from, a database system related data, objects, and Webpage content. With a multi-tenant system, data for multiple tenants may be stored in the same physical database object in tenant data storage 22, however, tenant data typically is arranged in the storage medium(s) of tenant data storage 22 so that data of one tenant is kept logically separate from that of other tenants so that one tenant does not have access to another tenant's data, unless such data is expressly shared. In certain implementations, system 16 implements applications other than, or in addition to, a CRM application. For example, system 16 may provide tenant access to multiple hosted (standard and custom) applications, including a CRM application. User (or third party developer) applications, which may or may not include CRM, may be supported by the application platform 18, which manages creation, storage of the applications into one or more database objects and executing of the applications in a virtual machine in the process space of the system 16.

One arrangement for elements of system 16 is shown in FIGS. 5A and 5B, including a network interface 20, application platform 18, tenant data storage 22 for tenant data 23, system data storage 24 for system data 25 accessible to system 16 and possibly multiple tenants, program code 26 for implementing various functions of system 16, and a process space 28 for executing MTS system processes and tenant-specific processes, such as running applications as part of an application hosting service. Additional processes that may execute on system 16 include database indexing processes.

Several elements in the system shown in FIG. 5A include conventional, well-known elements that are explained only briefly here. For example, each user system 12 could include a desktop personal computer, workstation, laptop, PDA, cell phone, or any wireless access protocol (WAP) enabled device or any other computing device capable of interfacing directly or indirectly to the Internet or other network connection. The term “computing device” is also referred to herein simply as a “computer”. User system 12 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 12 to access, process and view information, pages and applications available to it from system 16 over network 14. Each user system 12 also typically includes one or more user input devices, such as a keyboard, a mouse, trackball, touch pad, touch screen, pen or the like, for interacting with a GUI provided by the browser on a display (e.g., a monitor screen, LCD display, OLED display, etc.) of the computing device in conjunction with pages, forms, applications and other information provided by system 16 or other systems or servers. Thus, “display device” as used herein can refer to a display of a computer system such as a monitor or touch-screen display, and can refer to any computing device having display capabilities such as a desktop computer, laptop, tablet, smartphone, a television set-top box, or wearable device such Google Glass® or other human body-mounted display apparatus. For example, the display device can be used to access data and applications hosted by system 16, and to perform searches on stored data, and otherwise allow a user to interact with various GUI pages that may be presented to a user. As discussed above, implementations are suitable for use with the Internet, although other networks can be used instead of or in addition to the Internet, such as an intranet, an extranet, a virtual private network (VPN), a non-TCP/IP based network, any LAN or WAN or the like.

According to one implementation, each user system 12 and all of its components are operator configurable using applications, such as a browser, including computer code run using a central processing unit such as an Intel Pentium® processor or the like. Similarly, system 16 (and additional instances of an MTS, where more than one is present) and all of its components might be operator configurable using application(s) including computer code to run using processor system 17, which may be implemented to include a central processing unit, which may include an Intel Pentium® processor or the like, and/or multiple processor units. Non-transitory computer-readable media can have instructions stored thereon/in, that can be executed by or used to program a computing device to perform any of the methods of the implementations described herein. Computer program code 26 implementing instructions for operating and configuring system 16 to intercommunicate and to process web pages, applications and other data and media content as described herein is preferably downloadable and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any other type of computer-readable medium or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for the disclosed implementations can be realized in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to some implementations, each system 16 is configured to provide web pages, forms, applications, data and media content to user (client) systems 12 to support the access by user systems 12 as tenants of system 16. As such, system 16 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to refer to one type of computing device such as a system including processing hardware and process space(s), an associated storage medium such as a memory device or database, and, in some instances, a database application (e.g., OODBMS or RDBMS) as is well known in the art. It should also be understood that “server system” and “server” are often used interchangeably herein. Similarly, the database objects described herein can be implemented as single databases, a distributed database, a collection of distributed databases, a database with redundant online or offline backups or other redundancies, etc., and might include a distributed database or storage network and associated processing intelligence.

FIG. 5B shows a block diagram of an example of some implementations of elements of FIG. 5A and various possible interconnections between these elements. That is, FIG. 5B also illustrates environment 10. However, in FIG. 5B elements of system 16 and various interconnections in some implementations are further illustrated. FIG. 5B shows that user system 12 may include processor system 12A, memory system 12B, input system 12C, and output system 12D. FIG. 5B shows network 14 and system 16. FIG. 5B also shows that system 16 may include tenant data storage 22, tenant data 23, system data storage 24, system data 25, User Interface (UI) 30, Application Program Interface (API) 32, PL/SOQL 34, save routines 36, application setup mechanism 38, application servers 50₁-50_{N}, system process space 52, tenant process spaces 54, tenant management process space 60, tenant storage space 62, user storage 64, and application metadata 66. In other implementations, environment 10 may not have the same elements as those listed above and/or may have other elements instead of, or in addition to, those listed above.

User system 12, network 14, system 16, tenant data storage 22, and system data storage 24 were discussed above in FIG. 5A. Regarding user system 12, processor system 12A may be any combination of one or more processors. Memory system 12B may be any combination of one or more memory devices, short term, and/or long term memory. Input system 12C may be any combination of input devices, such as one or more keyboards, mice, trackballs, scanners, cameras, and/or interfaces to networks. Output system 12D may be any combination of output devices, such as one or more monitors, printers, and/or interfaces to networks. As shown by FIG. 5B, system 16 may include a network interface 20 (of FIG. 5A) implemented as a set of application servers 50, an application platform 18, tenant data storage 22, and system data storage 24. Also shown is system process space 52, including individual tenant process spaces 54 and a tenant management process space 60. Each application server 50 may be configured to communicate with tenant data storage 22 and the tenant data 23 therein, and system data storage 24 and the system data 25 therein to serve requests of user systems 12. The tenant data 23 might be divided into individual tenant storage spaces 62, which can be either a physical arrangement and/or a logical arrangement of data. Within each tenant storage space 62, user storage 64 and application metadata 66 might be similarly allocated for each user. For example, a copy of a user's most recently used (MRU) items might be stored to user storage 64. Similarly, a copy of MRU items for an entire organization that is a tenant might be stored to tenant storage space 62. A UI 30 provides a user interface and an API 32 provides an application programmer interface to system 16 resident processes to users and/or developers at user systems 12. The tenant data and the system data may be stored in various databases, such as one or more Oracle® databases.

Application platform 18 includes an application setup mechanism 38 that supports application developers' creation and management of applications, which may be saved as metadata into tenant data storage 22 by save routines 36 for execution by subscribers as one or more tenant process spaces 54 managed by tenant management process 60 for example. Invocations to such applications may be coded using PL/SOQL 34 that provides a programming language style interface extension to API 32. A detailed description of some PL/SOQL language implementations is discussed in commonly assigned U.S. Pat. No. 7,730,478, titled METHOD AND SYSTEM FOR ALLOWING ACCESS TO DEVELOPED APPLICATIONS VIA A MULTI-TENANT ON-DEMAND DATABASE SERVICE, by Craig Weissman, issued on Jun. 1, 2010, and hereby incorporated by reference in its entirety and for all purposes. Invocations to applications may be detected by one or more system processes, which manage retrieving application metadata 66 for the subscriber making the invocation and executing the metadata as an application in a virtual machine.

Each application server 50 may be communicably coupled to database systems, e.g., having access to system data 25 and tenant data 23, via a different network connection. For example, one application server 50₁ might be coupled via the network 14 (e.g., the Internet), another application server 50_{N-1} might be coupled via a direct network link, and another application server 50_{N} might be coupled by yet a different network connection. Transfer Control Protocol and Internet Protocol (TCP/IP) are typical protocols for communicating between application servers 50 and the database system. However, it will be apparent to one skilled in the art that other transport protocols may be used to optimize the system depending on the network interconnect used.

In certain implementations, each application server 50 is configured to handle requests for any user associated with any organization that is a tenant. Because it is desirable to be able to add and remove application servers from the server pool at any time for any reason, there is preferably no server affinity for a user and/or organization to a specific application server 50. In one implementation, therefore, an interface system implementing a load balancing function (e.g., an F5 Big-IP load balancer) is communicably coupled between the application servers 50 and the user systems 12 to distribute requests to the application servers 50. In one implementation, the load balancer uses a least connections algorithm to route user requests to the application servers 50. Other examples of load balancing algorithms, such as round robin and observed response time, also can be used. For example, in certain implementations, three consecutive requests from the same user could hit three different application servers 50, and three requests from different users could hit the same application server 50. In this manner, by way of example, system 16 is multi-tenant, wherein system 16 handles storage of, and access to, different objects, data and applications across disparate users and organizations.

As an example of storage, one tenant might be a company that employs a sales force where each salesperson uses system 16 to manage their sales process. Thus, a user might maintain contact data, leads data, customer follow-up data, performance data, goals and progress data, etc., all applicable to that user's personal sales process (e.g., in tenant data storage 22). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 16 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant-specific data, system 16 might also maintain system level data usable by multiple tenants or other data. Such system level data might include industry reports, news, postings, and the like that are sharable among tenants.

In certain implementations, user systems 12 (which may be client systems) communicate with application servers 50 to request and update system-level and tenant-level data from system 16 that may involve sending one or more queries to tenant data storage 22 and/or system data storage 24. System 16 (e.g., an application server 50 in system 16) automatically generates one or more SQL statements (e.g., one or more SQL queries) that are designed to access the desired information. System data storage 24 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects according to some implementations. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for case, account, contact, lead, and opportunity data objects, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. Commonly assigned U.S. Pat. No. 7,779,039, titled CUSTOM ENTITIES AND FIELDS IN A MULTI-TENANT DATABASE SYSTEM, by Weissman et al., issued on Aug. 17, 2010, and hereby incorporated by reference in its entirety and for all purposes, teaches systems and methods for creating custom objects as well as customizing standard objects in a multi-tenant database system. In certain implementations, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

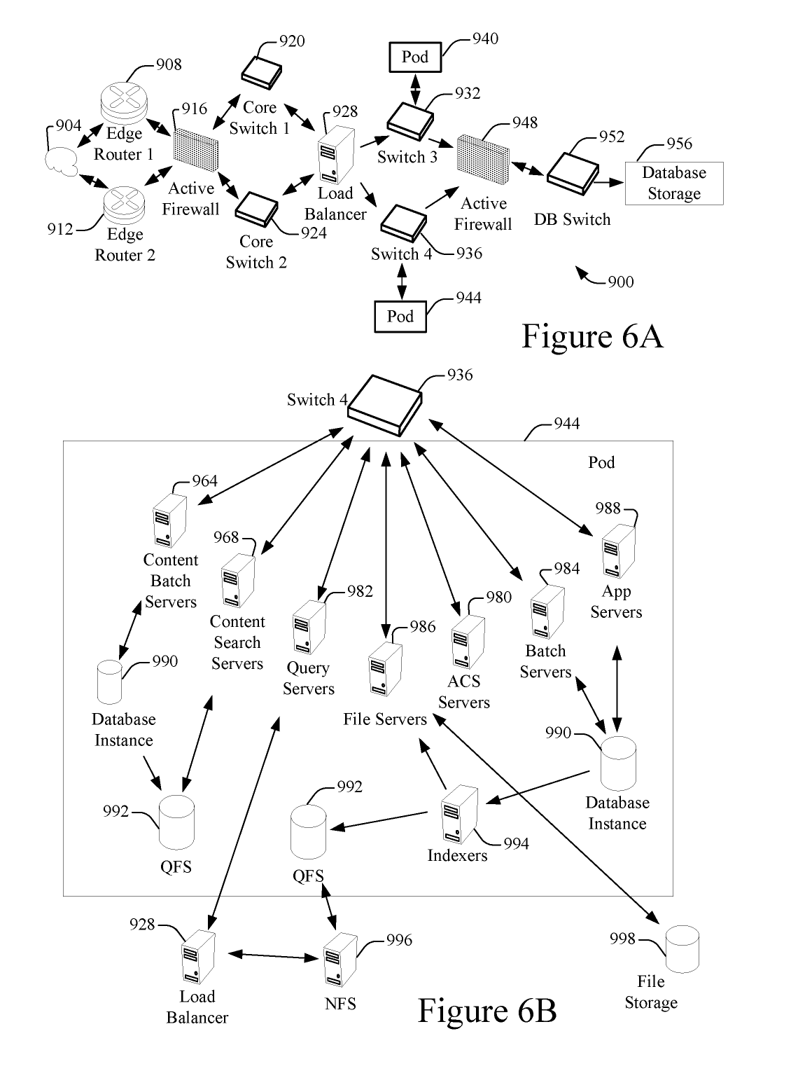

FIG. 6A shows a system diagram of an example of architectural components of an on-demand database service environment 900, in accordance with some implementations. A client machine located in the cloud 904, generally referring to one or more networks in combination, as described herein, may communicate with the on-demand database service environment via one or more edge routers 908 and 912. A client machine can be any of the examples of user systems 12 described above. The edge routers may communicate with one or more core switches 920 and 924 via firewall 916. The core switches may communicate with a load balancer 928, which may distribute server load over different pods, such as the pods 940 and 944. The pods 940 and 944, which may each include one or more servers and/or other computing resources, may perform data processing and other operations used to provide on-demand services. Communication with the pods may be conducted via pod switches 932 and 936. Components of the on-demand database service environment may communicate with a database storage 956 via a database firewall 948 and a database switch 952.

As shown in FIGS. 6A and 6B, accessing an on-demand database service environment may involve communications transmitted among a variety of different hardware and/or software components. Further, the on-demand database service environment 900 is a simplified representation of an actual on-demand database service environment. For example, while only one or two devices of each type are shown in FIGS. 6A and 6B, some implementations of an on-demand database service environment may include anywhere from one to many devices of each type. Also, the on-demand database service environment need not include each device shown in FIGS. 6A and 6B, or may include additional devices not shown in FIGS. 6A and 6B.

Moreover, one or more of the devices in the on-demand database service environment 900 may be implemented on the same physical device or on different hardware. Some devices may be implemented using hardware or a combination of hardware and software. Thus, terms such as “data processing apparatus,” “machine,” “server” and “device” as used herein are not limited to a single hardware device, but rather include any hardware and software configured to provide the described functionality.

The cloud 904 is intended to refer to a data network or combination of data networks, often including the Internet. Client machines located in the cloud 904 may communicate with the on-demand database service environment to access services provided by the on-demand database service environment. For example, client machines may access the on-demand database service environment to retrieve, store, edit, and/or process information.

In some implementations, the edge routers 908 and 912 route packets between the cloud 904 and other components of the on-demand database service environment 900. The edge routers 908 and 912 may employ the Border Gateway Protocol (BGP). The BGP is the core routing protocol of the Internet. The edge routers 908 and 912 may maintain a table of IP networks or ‘prefixes’, which designate network reachability among autonomous systems on the Internet.

In one or more implementations, the firewall 916 may protect the inner components of the on-demand database service environment 900 from Internet traffic. The firewall 916 may block, permit, or deny access to the inner components of the on-demand database service environment 900 based upon a set of rules and other criteria. The firewall 916 may act as one or more of a packet filter, an application gateway, a stateful filter, a proxy server, or any other type of firewall.

In some implementations, the core switches 920 and 924 are high-capacity switches that transfer packets within the on-demand database service environment 900. The core switches 920 and 924 may be configured as network bridges that quickly route data between different components within the on-demand database service environment. In some implementations, the use of two or more core switches 920 and 924 may provide redundancy and/or reduced latency.

In some implementations, the pods 940 and 944 may perform the core data processing and service functions provided by the on-demand database service environment. Each pod may include various types of hardware and/or software computing resources. An example of the pod architecture is discussed in greater detail with reference to FIG. 6B.

In some implementations, communication between the pods 940 and 944 may be conducted via the pod switches 932 and 936. The pod switches 932 and 936 may facilitate communication between the pods 940 and 944 and client machines located in the cloud 904, for example via core switches 920 and 924. Also, the pod switches 932 and 936 may facilitate communication between the pods 940 and 944 and the database storage 956.

In some implementations, the load balancer 928 may distribute workload between the pods 940 and 944. Balancing the on-demand service requests between the pods may assist in improving the use of resources, increasing throughput, reducing response times, and/or reducing overhead. The load balancer 928 may include multilayer switches to analyze and forward traffic.

In some implementations, access to the database storage 956 may be guarded by a database firewall 948. The database firewall 948 may act as a computer application firewall operating at the database application layer of a protocol stack. The database firewall 948 may protect the database storage 956 from application attacks such as structure query language (SQL) injection, database rootkits, and unauthorized information disclosure.

In some implementations, the database firewall 948 may include a host using one or more forms of reverse proxy services to proxy traffic before passing it to a gateway router. The database firewall 948 may inspect the contents of database traffic and block certain content or database requests. The database firewall 948 may work on the SQL application level atop the TCP/IP stack, managing applications' connection to the database or SQL management interfaces as well as intercepting and enforcing packets traveling to or from a database network or application interface.

In some implementations, communication with the database storage 956 may be conducted via the database switch 952. The multi-tenant database storage 956 may include more than one hardware and/or software components for handling database queries. Accordingly, the database switch 952 may direct database queries transmitted by other components of the on-demand database service environment (e.g., the pods 940 and 944) to the correct components within the database storage 956.

In some implementations, the database storage 956 is an on-demand database system shared by many different organizations. The on-demand database service may employ a multi-tenant approach, a virtualized approach, or any other type of database approach. On-demand database services are discussed in greater detail with reference to FIGS. 6A and 6B.

FIG. 6B shows a system diagram further illustrating an example of architectural components of an on-demand database service environment, in accordance with some implementations. The pod 944 may be used to render services to a user of the on-demand database service environment 900. In some implementations, each pod may include a variety of servers and/or other systems. The pod 944 includes one or more content batch servers 964, content search servers 968, query servers 982, file servers 986, access control system (ACS) servers 980, batch servers 984, and app servers 988. Also, the pod 944 includes database instances 990, quick file systems (QFS) 992, and indexers 994. In one or more implementations, some or all communication between the servers in the pod 944 may be transmitted via the switch 936.

In some implementations, the app servers 988 may include a hardware and/or software framework dedicated to the execution of procedures (e.g., programs, routines, scripts) for supporting the construction of applications provided by the on-demand database service environment 900 via the pod 944. In some implementations, the hardware and/or software framework of an app server 988 is configured to execute operations of the services described herein, including performance of one or more of the operations of methods described herein with reference to FIGS. 1-4. In alternative implementations, two or more app servers 988 may be included to perform such methods, or one or more other servers described herein can be configured to perform part or all of the disclosed methods.

The content batch servers 964 may handle requests internal to the pod. These requests may be long-running and/or not tied to a particular customer. For example, the content batch servers 964 may handle requests related to log mining, cleanup work, and maintenance tasks.

The content search servers 968 may provide query and indexer functions. For example, the functions provided by the content search servers 968 may allow users to search through content stored in the on-demand database service environment.

The file servers 986 may manage requests for information stored in the file storage 998. The file storage 998 may store information such as documents, images, and basic large objects (BLOBs). By managing requests for information using the file servers 986, the image footprint on the database may be reduced.

The query servers 982 may be used to retrieve information from one or more file systems. For example, the query system 982 may receive requests for information from the app servers 988 and then transmit information queries to the NFS 996 located outside the pod.

The pod 944 may share a database instance 990 configured as a multi-tenant environment in which different organizations share access to the same database. Additionally, services rendered by the pod 944 may call upon various hardware and/or software resources. In some implementations, the ACS servers 980 may control access to data, hardware resources, or software resources.

In some implementations, the batch servers 984 may process batch jobs, which are used to run tasks at specified times. Thus, the batch servers 984 may transmit instructions to other servers, such as the app servers 988, to trigger the batch jobs.

In some implementations, the QFS 992 may be an open source file system available from Sun Microsystems® of Santa Clara, Calif. The QFS may serve as a rapid-access file system for storing and accessing information available within the pod 944. The QFS 992 may support some volume management capabilities, allowing many disks to be grouped together into a file system. File system metadata can be kept on a separate set of disks, which may be useful for streaming applications where long disk seeks cannot be tolerated. Thus, the QFS system may communicate with one or more content search servers 968 and/or indexers 994 to identify, retrieve, move, and/or update data stored in the network file systems 996 and/or other storage systems.

In some implementations, one or more query servers 982 may communicate with the NFS 996 to retrieve and/or update information stored outside of the pod 944. The NFS 996 may allow servers located in the pod 944 to access information to access files over a network in a manner similar to how local storage is accessed.

In some implementations, queries from the query servers 922 may be transmitted to the NFS 996 via the load balancer 928, which may distribute resource requests over various resources available in the on-demand database service environment. The NFS 996 may also communicate with the QFS 992 to update the information stored on the NFS 996 and/or to provide information to the QFS 992 for use by servers located within the pod 944.

In some implementations, the pod may include one or more database instances 990. The database instance 990 may transmit information to the QFS 992. When information is transmitted to the QFS, it may be available for use by servers within the pod 944 without using an additional database call.

In some implementations, database information may be transmitted to the indexer 994. Indexer 994 may provide an index of information available in the database 990 and/or QFS 992. The index information may be provided to file servers 986 and/or the QFS 992.

While some of the disclosed implementations may be described with reference to a system having an application server providing a front end for an on-demand database service capable of supporting multiple tenants, the disclosed implementations are not limited to multi-tenant databases nor deployment on application servers. Some implementations may be practiced using various database architectures such as ORACLE®, DB2® by IBM and the like without departing from the scope of the implementations claimed.

It should be understood that some of the disclosed implementations can be embodied in the form of control logic using hardware and/or computer software in a modular or integrated manner. Other ways and/or methods are possible using hardware and a combination of hardware and software.

Any of the disclosed implementations may be embodied in various types of hardware, software, firmware, and combinations thereof. For example, some techniques disclosed herein may be implemented, at least in part, by computer-readable media that include program instructions, state information, etc., for performing various services and operations described herein. Examples of program instructions include both machine code, such as produced by a compiler, and files containing higher-level code that may be executed by a computing device such as a server or other data processing apparatus using an interpreter. Examples of computer-readable media include, but are not limited to: magnetic media such as hard disks, floppy disks, and magnetic tape; optical media such as flash memory, compact disk (CD) or digital versatile disk (DVD); magneto-optical media; and hardware devices specially configured to store program instructions, such as read-only memory (“ROM”) devices and random access memory (“RAM”) devices. A computer-readable medium may be any combination of such storage devices.

Any of the operations and techniques described in this application may be implemented as software code to be executed by a processor using any suitable computer language such as, for example, Java, C++ or Perl using, for example, object-oriented techniques. The software code may be stored as a series of instructions or commands on a computer-readable medium. Computer-readable media encoded with the software/program code may be packaged with a compatible device or provided separately from other devices (e.g., via Internet download). Any such computer-readable medium may reside on or within a single computing device or an entire computer system, and may be among other computer-readable media within a system or network. A computer system or computing device may include a monitor, printer, or other suitable display for providing any of the results mentioned herein to a user.

While various implementations have been described herein, it should be understood that they have been presented by way of example only, and not limitation. Thus, the breadth and scope of the present application should not be limited by any of the implementations described herein, but should be defined only in accordance with the following and later-submitted claims and their equivalents.

What is claimed is:

1. A database system for displaying feed content to a first user of an enterprise social networking system implemented in a computing environment having a plurality of member organizations, the database system comprising:
a processor; and
a memory storing instructions configurable to cause:
processing training content associated with the first user of the enterprise social networking system, the first user being affiliated with a first one of the plurality of member organizations, the training content being content with which the first user has interacted;
retrieving prospective content from a database of the database system, the prospective content being available to users affiliated with the first member organization;
calculating, based on actions taken by the first user with respect to the training content, a plurality of correspondence characteristics associated with the prospective content;
identifying, using the correspondence characteristics, a subset of the prospective content for presentation to the first user;
responsive to identifying the subset of the prospective content for presentation to the first user, displaying, on a display of a device of the first user, a feed of the enterprise social networking system, the feed comprising the subset of the prospective content;
determining that the first user has interacted with the subset of the prospective content; and
updating, based on an attribute of the interaction of the first user with the subset of the prospective content, at least one of the correspondence characteristics.

2. The database system of claim 1, wherein the training content includes one or more of: a search, a post, a comment, a file, a topic, a profile of a second user of the social networking system, a group of users of the social networking system, a Customer Relationship Management (CRM) record, a link, and/or a bookmark.

3. The database system of claim 2, wherein the actions taken by the first user with respect to the training content include one or more of: subscribing to a topic, following the second user, searching for a term, becoming a member of the group of users of the social networking system, generating or modifying the CRM record, viewing the file, uploading the file, commenting on the file, liking the file, sharing the file, modifying the file, authoring the post, commenting on the post, liking the post, sharing the post, and/or bookmarking a post or an object.

4. The database system of claim 1, wherein processing the training content includes extracting a plurality of keywords from the training content.

5. The database system of claim 1, the processor and the memory further configurable to cause:
determining that the training content is incomplete; and
accessing, responsive to determining that the training content is incomplete, supplemental content; and
wherein the plurality of correspondence characteristics are calculated based on the supplemental content.

6. The database system of claim 5, wherein the supplemental content comprises first data corresponding to the first user, the first data being profile information associated with an external system the external system being external from the enterprise social networking system.

7. The system of claim 5, the processor and the memory further configurable to cause:
identifying a second user of the social networking system as being similar to the first user; and
wherein the supplemental content comprises historical activity data associated with the second user.

8. The database system of claim 1, wherein the a subset of the prospective content is identified based on a level of activity associated with the prospective content, the level of activity corresponding to interactions with the subset of the prospective content by users affiliated with the first member organization.

9. A method for displaying feed content to a first user of an enterprise social networking system implemented in a computing environment having a plurality of member organizations, the method comprising:
processing training content associated with the first user of the enterprise social networking system, the first user being affiliated with a first one of the plurality of member organizations, the training content being content with which the first user has interacted;
retrieving prospective content from a database of a database system, the prospective content being available to users affiliated with the first member organization;
calculating, based on actions taken by the first user with respect to the training content, a plurality of correspondence characteristics associated with the prospective content;
identifying, using the correspondence characteristics, a subset of the prospective content for presentation to the first user;
responsive to identifying the subset of the prospective content for presentation to the first user, causing display of, on a display of a device of the first user, a feed of the enterprise social networking system, the feed comprising the subset of the prospective content;
determining that the first user has interacted with the subset of the prospective content; and
updating, based on an attribute of the interaction of the first user with the subset of the prospective content, at least one of the correspondence characteristics.

10. The method of claim 9, wherein the training content includes one or more of: a search, a post, a comment, a file, a topic, a profile of a second user of the social networking system, a group of users of the social networking system, a Customer Relationship Management (CRM) record, a link, and/or a bookmark.

11. The method of claim 10, wherein the actions taken by the first user with respect to the training content include one or more of: subscribing to a topic, following the second user, searching for a term, becoming a member of the group of users of the social networking system, generating or modifying the CRM record, viewing the file, uploading the file, commenting on the file, liking the file, sharing the file, modifying the file, authoring the post, commenting on the post, liking the post, sharing the post, and/or bookmarking a post or an object.

12. The method of claim 9, wherein processing the training content includes extracting a plurality of keywords from the training content.

13. The method of claim 9, the method further comprising:
determining that the training content is incomplete; and
accessing, responsive to determining that the training content is incomplete, supplemental content; and
wherein the plurality of correspondence characteristics are calculated based on the supplemental content.

14. The method of claim 13, wherein the supplemental content comprises first data corresponding to the first user, the first data being profile information associated with an external system the external system being external from the enterprise social networking system.

15. The method of claim 13, the method further comprising:
identifying a second user of the social networking system as being similar to the first user; and
wherein the supplemental content comprises historical activity data associated with the second user.

16. A computer program product for displaying feed content to a first user of an enterprise social networking system implemented in a computing environment having a plurality of member organizations, the computer program product comprising computer-readable program code capable of being executed by one or more processors when retrieved from a non-transitory computer-readable medium, the program code comprising instructions configurable to cause:
processing training content associated with the first user of the enterprise social networking system, the first user being affiliated with a first one of the plurality of member organizations, the training content being content with which the first user has interacted;
retrieving prospective content from a database of a database system, the prospective content being available to users affiliated with the first member organization;
calculating, based on actions taken by the first user with respect to the training content, a plurality of correspondence characteristics associated with the prospective content;
identifying, using the correspondence characteristics, a subset of the prospective content for presentation to the first user;
responsive to identifying the subset of the prospective content for presentation to the first user, displaying, on a display of a device of the first user, a feed of the enterprise social networking system, the feed comprising the subset of the prospective content;
determining that the first user has interacted with the subset of the prospective content; and
updating, based on an attribute of the interaction of the first user with the subset of the prospective content, at least one of the correspondence characteristics.

17. The computer program product of claim 16, wherein the training content includes one or more of: a search, a post, a comment, a file, a topic, a profile of a second user of the social networking system, a group of users of the social networking system, a Customer Relationship Management (CRM) record, a link, and/or a bookmark.

18. The computer program product of claim 17, wherein the actions taken by the first user with respect to the training content include one or more of: subscribing to a topic, following the second user, searching for a term, becoming a member of the group of users of the social networking system, generating or modifying the CRM record, viewing the file, uploading the file, commenting on the file, liking the file, sharing the file, modifying the file, authoring the post, commenting on the post, liking the post, sharing the post, and/or bookmarking a post or an object.

19. The computer program product of claim 16, wherein processing the training content includes extracting a plurality of keywords from the training content.

20. The computer program product of claim 16, the instructions further configurable to cause:
determining that the training content is incomplete; and
accessing, responsive to determining that the training content is incomplete, supplemental content; and
wherein the plurality of correspondence characteristics are calculated based on the supplemental content.
